(19) United States
(12) Patent Application Publication
(10) Pub. No.: US 2024/0127003 A1
(43) Pub. Date: Apr. 18, 2024

(54) INFORMATION PROCESSING APPARATUS

(71) Applicant: NEC solution Innovators, Ltd., Tokyo-ku, Tokyo (JP)

(72) Inventor: Takao KOIZUMI, Tokyo (JP)

(73) Assignee: NEC solution Innovators, Ltd., Tokyo-ku, Tokyo (JP)

(21) Appl. No.: 18/278,093

(22) PCT Filed: Jan. 12, 2022
(86) PCT No.: PCT/JP2022/000732

§ 371 Date: Aug. 21, 2023

(30) Foreign Application Priority Data
Feb. 26, 2021 (JP) 2021-029501

(51) Int. Cl. G06F 40/56

(52) U.S. Cl. CPC G06F 40/56

(57) ABSTRACT

An information processing apparatus includes: a selecting unit that abstracts a plurality of inputs based on the plurality of inputs and selects a common concept that is an abstract concept common to the plurality of inputs; and a generating unit that generates output data including the common concept based on a result of the selection by the selecting unit.

### TECHNICAL FIELD

The present invention relates to an information processing apparatus, an information processing method, and a recording medium.

### BACKGROUND ART

An apparatus that generates another sentence based on a sentence is known.

For example, Patent Literature 1 describes a data generation apparatus that converts text in a source domain into text in a target domain. According to Patent Literature 1, the data generation apparatus includes a text acquiring unit, a text replacing unit, and a text output unit. The text acquiring unit acquires text in a source domain and target domain information indicating a target domain. The text replacing unit provides an input based on the acquired source domain text and target domain information for a learned model generated by performing machine learning based on text in a target domain and target domain information for machine learning, calculates probability information on the appearance probability of a word candidate at a word position in the text in the source domain, and generates replacement text in which a word at the word position is replaced with the word candidate at the word position based on the calculated probability information. The text output unit then outputs the generated replacement text as text in the target domain.

### CITATION LIST

### Patent Literature

Patent Literature 1: Japanese Unexamined Patent Application Publication No. JP-A 2020-112915

### SUMMARY OF INVENTION

### Technical Problem

In the case of the technique described in Patent Literature 1, one sentence is replaced with another one sentence in a different domain. Therefore, for example, there is a problem that it is difficult to generate output data such as a sentence corresponding to a plurality of inputs such as a plurality of sentences.

Accordingly, an object of the present invention is to provide an information processing apparatus, an information processing method and a recording medium that solve the problem that it is difficult to generate output data corresponding to a plurality of inputs.

### Solution to Problem

In order to achieve the object, an information processing apparatus as an aspect of the present disclosure includes: a selecting unit that abstracts a plurality of inputs based on the plurality of inputs and selects a common concept that is an abstract concept common to the plurality of inputs; and a generating unit that generates output data including the common concept based on a result of the selection by the selecting unit.

Further, an information processing method as another aspect of the present disclosure is a method by an information processing apparatus and includes: abstracting a plurality of inputs based on the plurality of inputs and selecting a common concept that is an abstract concept common to the plurality of inputs; and generating output data including the common concept based on a result of the selection.

Further, a recording medium as another aspect of the present disclosure is a non-transitory computer-readable recording medium on which a computer program is recorded, and the computer program includes instructions for causing an information processing apparatus to realize processes to: abstract a plurality of inputs based on the plurality of inputs and select a common concept that is an abstract concept common to the plurality of inputs; and generate output data including the common concept based on a result of the selection.

### Advantageous Effects of Invention

With the respective configurations as described above, it is possible to provide an information processing apparatus, an information processing method and a recording medium that can generate output data corresponding to a plurality of inputs.

### BRIEF DESCRIPTION OF DRAWINGS

FIG. 1 a view showing an example of a sentence generation apparatus in a first example embodiment of the present disclosure.

FIG. 2 is a block diagram showing a configuration example of the sentence generation apparatus.

FIG. 3 is a view for explaining a conceptual example of an abstraction level.

FIG. 4 is a view for explaining the abstraction level.

FIG. 5 is a view sowing an example of processing when segmenting an input sentence into words.

FIG. 6 is a view showing an example of a word cloud sentence.

FIG. 7 is a view for explaining an example of processing for selecting a common concept.

FIG. 8 is a view showing an example of operation of the sentence generation apparatus.

FIG. 9 is a block diagram showing an example of a configuration of a search apparatus as another configuration example of the sentence generation apparatus.

FIG. 10 is a view showing an example of a hardware configuration of an information processing apparatus in a second example embodiment of the present disclosure.

FIG. 11 is a block diagram showing a configuration example of the information processing apparatus.

### DESCRIPTION OF EMBODIMENTS

### First Example Embodiment

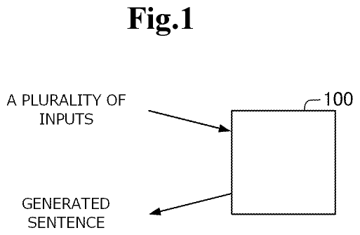

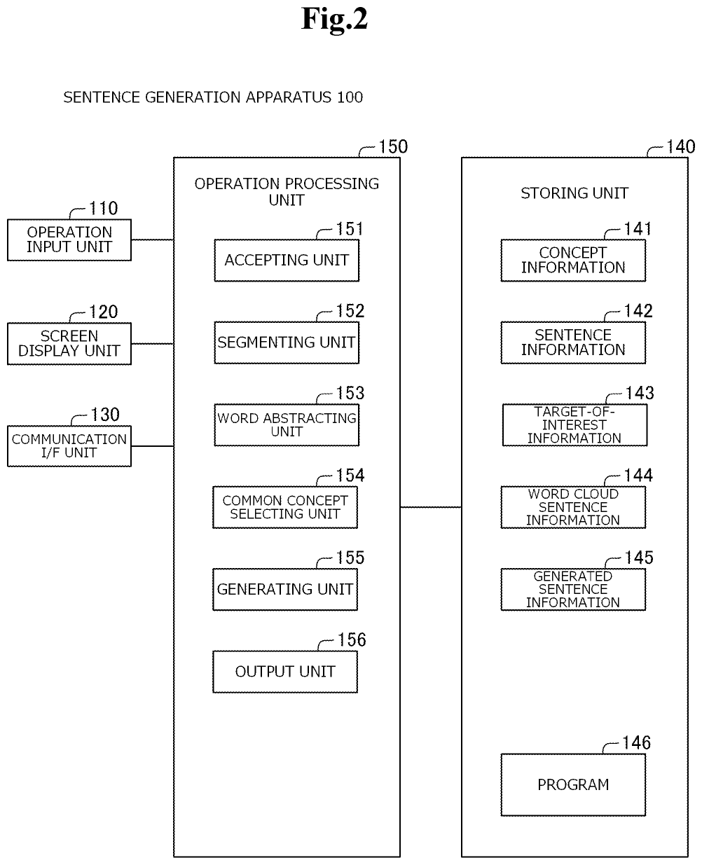

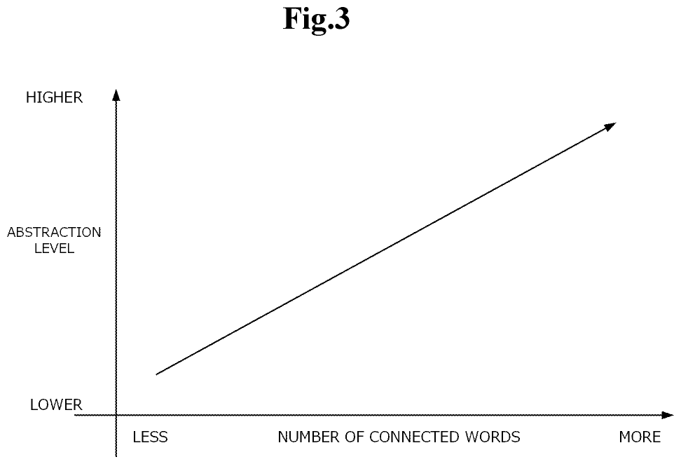

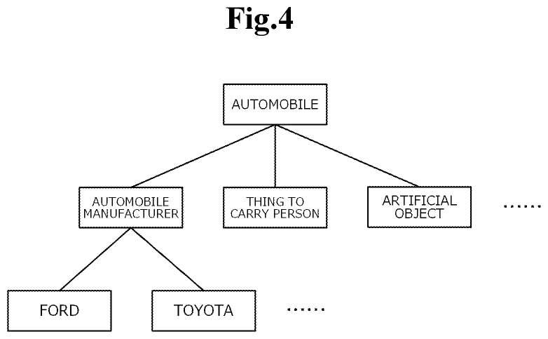

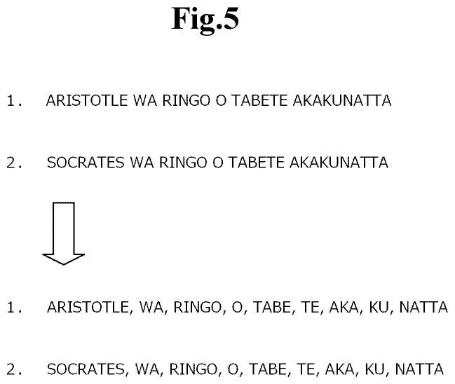

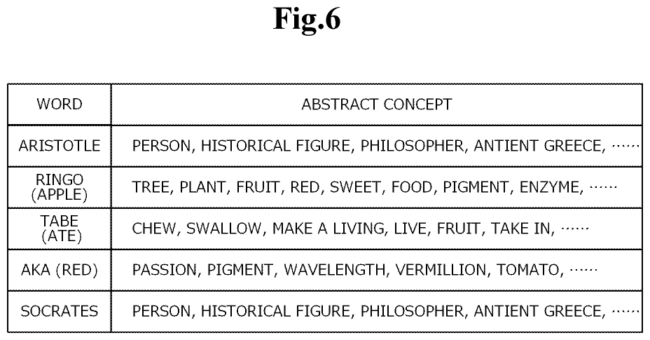

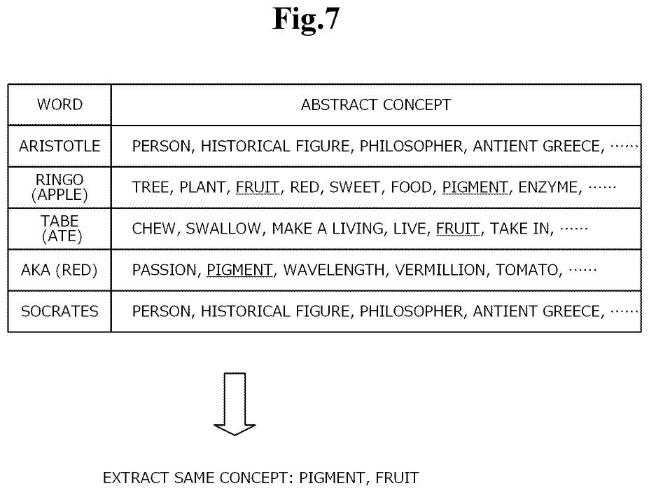

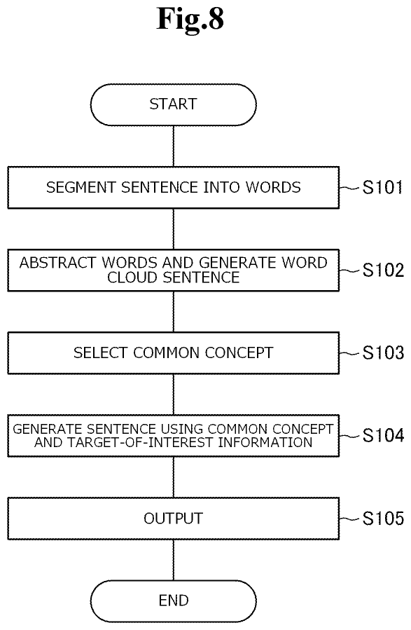

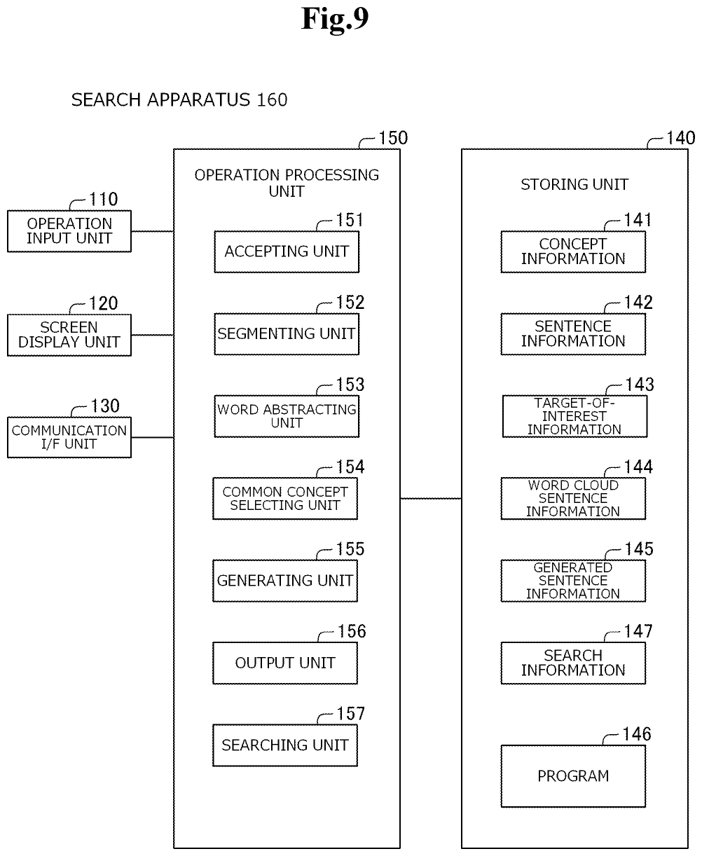

A first example embodiment of the present disclosure will be described with reference to FIGS. 1 to 8. FIG. 1 a view showing an example of a sentence generation apparatus 100. FIG. 2 is a block diagram showing a configuration example of the sentence generation apparatus 100. FIGS. 3 and 4 are views for explaining an abstraction level. FIG. 5 is a view sowing an example of processing when segmenting an input sentence into words. FIG. 6 is a view showing an example of a word cloud sentence. FIG. 7 is a view for explaining an example of processing for selecting a common concept. FIG. 8 is a view showing an example of operation of the sentence generation apparatus 100. FIG. 9 is a block diagram showing an example of a configuration of a search apparatus 160.

As shown in FIG. 1, in the first example embodiment of the present disclosure, the sentence generation apparatus 100, which is an information processing apparatus that generates a sentence based on a plurality of input sentences, will be described. As will be described later, the sentence generation apparatus 100 accepts an input of a plurality of sentences and information showing a target of interest. Then, the sentence generation apparatus 100 acquires a plurality of words by a method such as segmenting a sentence into words. Moreover, the sentence generation apparatus 100 generates a word cloud sentence by acquiring words with higher abstraction levels and words with lower abstraction levels than the acquired words. After that, the sentence generation apparatus 100 generates a sentence focusing on the target of interest based on the generated word cloud sentence.

FIG. 2 shows a configuration example of the sentence generation apparatus 100. Referring to FIG. 2, the sentence generation apparatus 100 has, for example, an operation input unit 110, a screen display unit 120, a communication I/F unit 130, a storing unit 140, and an operation processing unit 150 as main components.

The operation input unit 110 includes an operation input device such as a keyboard and a mouse. The operation input unit 110 detects an operation by, for example, a user using the sentence generation apparatus 100, and outputs to the operation processing unit 150.

The screen display unit 120 includes a screen display device such as an LCD (Liquid Crystal Display). The screen display unit 120 can display on a screen, for example, a variety of information stored in the storing unit 140 in response to an instruction from the operation processing unit 150.

The communication I/F unit 130 includes a data communication circuit. The communication OF unit 130 performs data communication with an external apparatus.

The storing unit 140 is a storage device such as a hard disk and a memory. The storing unit 140 stores processing information necessary for a variety of processing by the operation processing unit 150 and a program 146. The program 146 is loaded and executed by the operation processing unit 150 to implement various processing units. The program 146 is loaded in advance from an external apparatus or a recording medium via a data input/output function such as the communication OF unit 130, and stored in the storing unit 140. Main information stored in the storing unit 140 includes, for example, concept information 141, sentence information 142, target-of-interest information 143, word cloud sentence information 144, and generated sentence information 145.

The concept information 141 is information showing a relation, a connection and the like of words, groups of words, and the like. For example, the concept information 141 includes information that shows a connection of words and groups of words generated by connecting a word to a word with higher abstraction level and a word with lower abstraction level than the word (or a word with high abstraction level and a word with low abstraction level). The concept information 141 may also include, for example, information showing a connection of a word to a word and a group of words associated with the word. For example, the concept information 141 is acquired in advance from an external apparatus and the like via the communication IN unit 130, and stored in the storing unit 140.

Here, an abstraction level is a concept such that a value increases as the number of connected words indicating the number of words and groups of words connected to a word and a group of words increases, for example, as shown in FIG. 3. For example, the concept information 141 as shown in FIG. 4 will be assumed in which a word “automobile” is connected to “automobile manufacturer”, “thing to carry person”, “artificial object” and the like and the word “automobile manufacturer” is connected to “Ford”, “Toyota” and the like. In this case, the word “automobile” connected to “automobile manufacturer” (connected to “Ford”, “Toyota” and the like), “thing to carry person”, “artificial object” and the like has the largest number of connected words among the above words. Consequently, in the case of the concept information 141 as described above, the word “automobile” is a word with highest abstraction level.

The abstraction level may be a value other than the value corresponding to the number of connected words. For example, the abstraction level may be a value determined in advance for each word or group of words.

The sentence information 142 shows an original sentence of a sentence to be generated, input into the sentence generation apparatus 100. For example, the sentence information 142 is updated when an accepting unit 151 accepts an input of a sentence from an external apparatus via the communication I/F unit 130 or when the accepting unit 151 accepts an input of a sentence in response to an operation of the operation input unit 110. For example, the sentence information 142 includes a plurality of sentences input into the sentence generation apparatus 100.

The target-of-interest information 143 shows a word or a group of words to be a target of interest when a new sentence is generated. The target of interest shown by the target-of-interest information 143 is, for example, any one of the words and groups of words in the sentence included by the sentence information 142. The target of interest may be, for example, a word or a group of words connected to a word in the sentence included by the sentence information 142, having a different abstraction level. The target-of-interest information 143 is updated, for example, when the accepting unit 151 accepts information indicating a target of interest from an external apparatus via the communication OF unit 130 or when the accepting unit 151 accepts information indicating a target of interest in response to an operation of the operation input unit 110.

The word cloud sentence information 144 is information in which each of the words acquired by segmenting the sentence included by the sentence information 142 is associated with a word and a group of words with different abstraction value from the acquired word, numerical information and so forth. The word cloud sentence information 144 is updated, for example, when a word abstracting unit 153 performs processing based on the result of segmentation of a sentence by a segmenting unit 152 and the concept information 141.

The generated sentence information 145 is information indicating a sentence generated by a generating unit 155 based on the sentence included by the sentence information 142. The generated sentence information 145 is updated when the generating unit 155 generates a sentence.

The operation processing unit 150 has an arithmetic logic unit such as a CPU and a peripheral circuit thereof. The operation processing unit 150 loads the program 146 from the storing unit 140 and executes the program 146 to make the abovementioned hardware and the program 146 cooperate and implement various processing units. Main processing units implemented by the operation processing unit 150 include, for example, the accepting unit 151, the segmenting unit 152, the word abstracting unit 153, a common concept selecting unit 154, the generating unit 155, and an output unit 156.

The accepting unit 151 accepts a sentence, information indicating a target of interest, and so forth. For example, the accepting unit 151 accepts a sentence, information indicating a target of interest, and so forth, from an external apparatus via the communication IN unit 130 and also accepts in response to an operation of the operation input unit 110. Then, the accepting unit 151 stores the accepted sentence as the sentence information 142 into the storing unit 140. Also, the accepting unit 151 stores the accepted information indicating the target of interest as the target-of-interest information 143 into the storing unit 140.

The segmenting unit 152 segments a sentence included by the sentence information 142 and acquires words included by the sentence. The segmenting unit 152 may segment the sentence at any timing. For example, the segmenting unit 152 may segment a new sentence at the timing when the new sentence is stored in the text information 142 or segment a sentence included by the sentence information 142 when the generating unit 155 is about to generate a new sentence.

For example, the segmenting unit 152 segments a sentence into words by performing natural language processing such as morphological analysis on the sentence. FIG. 5 shows a specific example of processing by the segmenting unit 152. Referring to FIG. 5, for example, the sentence information 142 includes two sentences, “Aristotle wa ringo o tabe te aka ku natta (Aristotle ate an apple and turned red)” and “Socrates wa ringo o tabe te aka ku natta (Socrates ate an apple and turned red)”. In such a case, the segmenting unit 152 performs morphological analysis on each of the above sentences and thereby, for example, segments the sentence “Aristotle wa ringo o tabe te aka ku natta” into words “Aristotle”, “wa”, “ringo”, “o”, “tabe”, “te”, “aka”, “ku”, “natta”, and segments the sentence “Socrates wa ringo o tabe te aka ku natta” into words “Socrates”, “wa”, “ringo”, “o”, “tabe”, “te”, “aka”, “ku”, “natta”.

For example, in the above manner, the segmenting unit 152 performs natural language processing on a sentence to acquire words included by the sentence.

The word abstracting unit 153 performs abstraction of words, and the like, to generate a word cloud sentence from the words. Then, the word abstracting unit 153 stores the generated word cloud sentence as the word cloud sentence information 144 into storing unit 140.

Specifically, for example, the word abstracting unit 153 refers to the concept information 141 and thereby acquires, for each of the words acquired as a result of the processing by the segmenting unit 152, a word with higher abstraction level than the word and a word with lower abstraction level than the word (alternatively, a group of words with different abstraction level, an associated word, and the like). Then, the word abstracting unit 153 generates a word cloud sentence in which the word is associated with the word with higher abstraction level or the word with lower abstraction level than the word (for example, expressed as an abstract concept).

FIG. 6 shows an example of a word cloud sentence generate by the word abstracting unit 153. Specifically, FIG. 6 shows an example of processing by the word abstracting unit 153 in a case where the segmenting unit 152 acquires words “Aristotle”, “wa”, “ringo”, “o”, “tabe”, “te”, “aka”, “ku”, “natta” and words “Socrates”, “wa”, “ringo”, “o”, “tabe”, “te”, “aka”, “ku”, “natta”. Referring to FIG. 6, for example, the word abstracting unit 153 refers to the concept information 141, and thereby acquires words such as “Aristotle” and “Socrates”, and words and groups of words connected to the words in the concept information 141, such as “person”, “historical figure”, “philosopher”, “ancient Greece”, and so forth. Then, the word abstracting unit 153 associates the words such as “Aristotle” and “Socrates” with “person”, “historical figure”, “philosopher”, “ancient Greece”, and so forth. Similarly, for example, the word abstracting unit 153 refers to the concept information 141, and thereby associates the word “ringo (apple)” with “tree”, “plant”, “fruit”, “red”, “sweet”, “food”, “spring”, “pigment”, “enzyme”, and so forth. The word abstracting unit 153 also associates the word “tabe (ate)” with “chew”, “swallow”, “make a living”, “live”, “fruit”, “take in”, and so forth. The word abstracting unit 153 also associates the word “aka (red)” with “passion”, “pigment”, “wavelength”, “vermillion”, “tomato”, and so forth. For example, the word abstracting unit 153 generates a word cloud sentence by associating the words with the abstract concepts as described above. The abstract concepts may include numerical information obtained by quantifying heat, color, sound, scent, and the like.

The common concept selecting unit 154 selects an abstract concept common to words, for example, with reference to the word cloud sentence information 144. For example, the common concept selecting unit 154 refers to the word cloud sentence information 144, and thereby selects an abstract concept common to a target word of interest and another word.

Specifically, referring to FIG. 7, in the case of the word cloud sentence illustrated in FIG. 6, the abstract concepts corresponding to the word “ringo (apple)” include “fruit”, and the abstract concepts corresponding to the word “tabe (ate)” include “fruit”. Likewise, the abstract concepts corresponding to the word “ringo” include “pigment”, and the abstract concepts corresponding to the word “aka (red)” include “pigment”. That is to say, the abstract concepts such as “pigment” and “fruit” are common. Then, the common concept selecting unit 154 selects “pigment”, “fruit”, and so forth as common abstract concepts.

The generating unit 155 generates a new sentence using the common concept selected by the common concept selecting unit 154 and the target of interest indicated by the target-of-interest information 143. It is assumed that the form of a sentence to be generated by the generating unit 155 is set in advance such as “xx contains yy” and “aa acts on bb”. The generating unit 155 generates a new sentence with the target of interest indicated by the target-of-interest information 143 as the subject so as to take the form of a sentence set in advance. The generating unit 155 may be configured to select the form of a sentence to be generated in accordance with a target of interest and so forth.

For example, the generating unit 155 abstracts and summarizes portions of a plurality of sentences included by the sentence information 142, which are different words and can be regarded as having the same or similar concept. For example, Aristotle and Socrates have in common “person”, “historical figure”, “philosopher”, and so forth. Therefore, the generating unit 155 summarizes Aristotle and Socrates as “person”, “historical figure”, “philosopher” and so forth.

Then, the generating unit 155 generates a new sentence by rearranging the words common to the respective sentences and the selected abstract concepts so as to take a preset form with the target of interest “ringo (apple)” as the subject. At this time, the generating unit 155 may delete a word related to the subject, such as a verb. For example, in the case of the example described in this example embodiment, the subject is changed from “person” and the like to “ringo”. Therefore, the generating unit 155 can delete words “tabe” and “te”. The generating unit 155 may also be configured to delete abstract concepts included by the deleted words. For example, in the case of the example described in this example embodiment, the generating unit 155 can delete the word “fruit” included by “tabe (ate)”. Moreover, when generating a new sentence as described above, the generating unit 155 can supplement a particle using a known technique.

For example, as a result of the processing as described above, the generating unit 155 can newly generate a sentence “Ringo (apple), (ni) wa, hito (person)/historical figure/philosopher/. . . , o, aka (red), ku (sum), sikiso (pigment)/fruit, (ga hukumare te iru)”. Alternatively, the generating unit 155 may generate one sentence “Ringo ni wa hito o aka ku sum sikiso ga hukumare te iru (An apple contains a pigment that makes a person red)” by summarizing a plurality of parallel words.

The generating unit 155 can determine whether or not a plurality of words are similar based on, for example, the overlap ratio of abstract concepts (may be any value). The generating unit 155 may determine whether or not words are similar by a method other than the method illustrated above. Moreover, the generating unit 155 may be configured to, when there are a plurality of common concepts, select a common concept to be adopted by any method.

The output unit 156 outputs the sentence generated by the generating unit 155. For example, the output unit 156 can display a sentence (for example, “ringo ni wa hito o aka ku sum sikiso ga hukumare te iru”) generated by the generating unit 155 on a screen of the screen display unit 120, or transmit to an external apparatus.

The above is the configuration example of the sentence generation apparatus 100. Subsequently, an example of operation of the sentence generation apparatus 100 will be described with reference to FIG. 8.

FIG. 8 shows an example of operation of the sentence generation apparatus 100. Referring to FIG. 8, the segmenting unit 152 segments a sentence included by the sentence information 142, and acquires words included by the sentence (step S101).

The word abstracting unit 153 performs abstraction of the words, and the like, and thereby generates a word cloud sentence from the words (step S102). For example, the word abstracting unit 153 refers to the concept information 141 and thereby acquires, for each of the words acquired as a result of the processing by the segmenting unit 152, a word with higher abstraction level or a word with lower abstraction level than the word (alternatively, a group of word with different abstraction level, an associated word, and the like). Consequently, the word abstracting unit 153 generates a word cloud sentence in which the word is associated with the word with higher abstraction level or the word with lower abstraction level than the word (for example, expressed as an abstract concept).

The common concept selecting unit 154 refers to the word cloud sentence information 144 and thereby selects an abstract concept common to the words. For example, the common concept selecting unit 154 refers to the word cloud sentence information 144 and thereby selects an abstract concept common to a target word of interest and another word (step 103).

The generating unit 155 generates a new sentence using the common concept selected by the common concept selecting unit 154 and a target of interest indicated by the target-of-interest information 143 (step S104). For example, the generating unit 155 abstracts and summarizes portions of a plurality of sentences included by the sentence information 142, which are different words and can be regarded as having the same or similar abstraction level and concept. Then, the generating unit 155 generates a new sentence by, for example, rearranging words common to the respective sentences and the selected abstract concepts so as to take a preset form with the target of interest “ringo” as the subject.

The output unit 156 outputs the sentence generated by the generating unit 155 (step S105).

Thus, the sentence generation apparatus 100 has the word abstracting unit 153, the common concept selecting unit 154, and the generating unit 155. With such a configuration, the generating unit 155 can generate a new sentence using a common concept selected by the common concept selecting unit 154 among the results of abstraction by the word abstracting unit 153. As a result, a sentence corresponding to a plurality of sentences can be generated.

Further, according to the above configuration, after the abstracted words are matched, the sentences are converted. This approach makes it possible to generate a sentence in which the idea of abduction is reflected, for example.

In this example embodiment, a case where the function as the sentence generation apparatus 100 is implemented by one information processing apparatus has been illustrated. However, the function as the sentence generation apparatus 100 may be implemented by a plurality of information processing apparatuses connected via a network, such as being implemented in the cloud.

Further, in this example embodiment, a case where the sentence generation apparatus 100 has the concept information 141 has been illustrated. However, the sentence generation apparatus 100 may be configured to utilize external information such as an external dictionary site or an encyclopedia site, instead of the concept information 141, for example. In a case where the sentence generation apparatus 100 has a configuration as described above, the sentence generation apparatus 100 may omit the concept information 141.

Further, in this example embodiment, a case where a sentence as output data is generated in response to an input of a plurality of sentences has been described. However, the sentence generation apparatus 100 may be configured to generate a sentence in response to an input other than sentences. For example, the sentence generation apparatus 100 may be configured to accept image data, sound data and the like (alternatively, image data and a sentence, and the like) as a plurality of inputs. In this case, the sentence generation apparatus 100 can acquire words and the like from the image data by performing a known image recognition process and the like. In other words, the sentence generation apparatus 100 may have, instead of the segmenting unit 152 or along with the segmenting unit 152, an image recognizing unit that acquires a word, a sentence and the like corresponding to the image data based on the image data. The image recognizing unit may be configured to acquire directly numerical information and the like as an abstract concept along with or instead of a word, a sentence and the like.

Further, the generating unit 155 may be configured to generate output data other than a sentence. That is to say, the present invention may be applied to a generation apparatus other than the sentence generation apparatus 100 that generates a sentence. For example, in a case where an abstract concept includes numerical information obtained by quantifying heat, color, sound, scent and the like, the numerical information may be included as a common concept. In such a case, the generating unit 155 may be configured to generate image data, sound data and the like generated based on the numerical information. Thus, the generating unit 155 may be configured to generate output data other than a sentence based on a common concept.

Further, FIG. 9 shows a configuration of a search apparatus 160 as another configuration example of the sentence generation apparatus 100. The search apparatus 160 is an information processing apparatus having a configuration as the sentence generation apparatus 100. Moreover, referring to FIG. 9, a storing unit 140 of the search apparatus 160 stores search information 147.

The search information 147 includes information for performing a search by a searching unit 157 to be described later. For example, the search information 147 can be generated by a generating unit 155 as output data and stored into the storing unit 150.

For example, the search information 147 can include information used when the generating unit 155 generates a sentence and the like, the generated sentence, and so forth. For example, in the search information 147, an original sentence of the generated sentence, information corresponding to the original sentence, and so forth, are associated with an abstract concept, a common concept and the like included in a word cloud sentence. Specifically, for example, it is assumed that a plurality of sentences related to Tsurugaoka Hachimangu Shrine are input and a common concept is selected by abstracting the plurality of input sentences. In this case, the search information 147 can be information in which information indicating Tsurugaoka Hachimangu Shrine, the input sentences, and the selected common concept are associated with each other.

Further, referring unit FIG. 9, the operation processing unit 150 can have the searching unit 157 in addition to the configuration described with reference to FIG. 2. In the case of the configuration shown in FIG. 9, the generating unit 155 can generate the search information 147 as output data and store into the storing unit 140.

The searching unit 157 searches the search information 147 in accordance with the search input information and the like having been input. For example, a plurality of sentences on a specific field of a person (for example, tourism field) are input as the search information 147. Then, the searching unit 157 extracts a common concept common to the plurality of input sentences using the segmenting unit 152, the word abstracting unit 153, the common concept selecting unit 154, and so forth. Then, the searching unit 157 searches the search information 147 using the extracted common concept as a search key. For example, the searching unit 157 can search the search information 147 for information that includes all of the common concepts extracted based on the search input information (alternatively, includes a predetermined number or a predetermined ratio or more). As the search input information, for example, an abstract concept corresponding to the common concept may be input as it is, or only one sentence may be input. In a case where only one sentence is input, the searching unit 157 can perform the search process using an abstract concept extracted using the segmenting unit 152 and the word abstracting unit 153.

### Second Example Embodiment

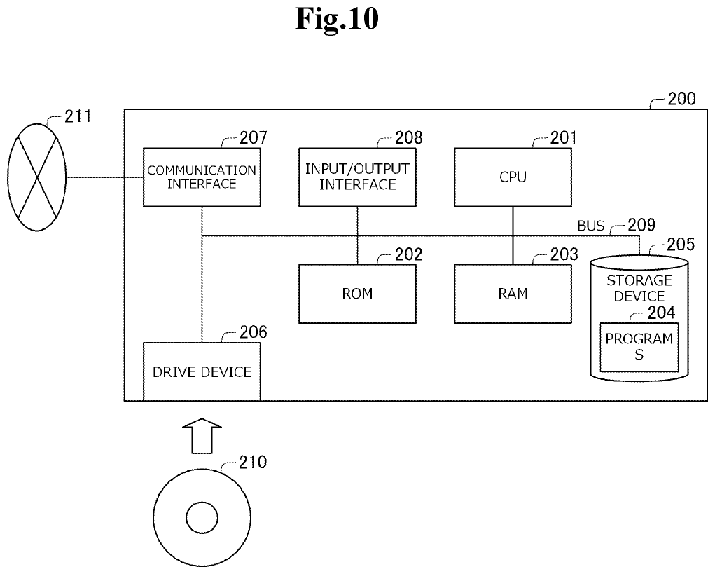

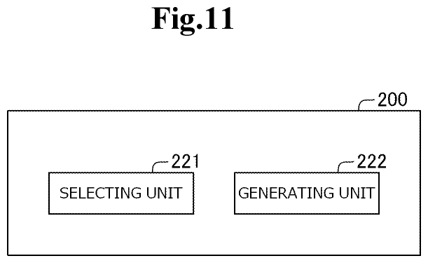

Next, a second example embodiment of the present disclosure will be described with reference to FIGS. 10 and 11. In the second example embodiment, the overview of a configuration of an information processing apparatus 200 will be described.

FIG. 10 shows an example of a hardware configuration of the information processing apparatus 200. Referring to FIG. 10, the information processing apparatus 200 has, as an example, the following hardware configuration including

a CPU (Central Processing Unit) 201 (arithmetic logic unit),

a ROM (Read Only Memory) 202 (memory unit),

a RAM (Random Access Memory) 203 (memory unit),

programs 204 loaded to the RAM 203,

a storage device 205 that stores the programs 204,

a drive device 206 that reads from and writes into a recording medium outside the information processing apparatus,

a communication interface 207 connected to a communication network 211 outside the information processing apparatus,

an input/output interface 208 that performs input and output of data, and a bus 209 that connects the components.

Further, the information processing apparatus 200 can implement functions as a selecting unit 221 and a generating unit 222 shown in FIG. 11 by acquisition and execution of the programs 204 by the CPU 201. The programs 204 are, for example, stored in advance in the storage device 205 or the ROM 202, and loaded and executed by the CPU 201 as necessary. The programs 204 may be delivered to the CPU 201 via the communication network 211, or may be stored in the recording medium 210 in advance and retrieved and delivered to the CPU 201 by the drive device 206.

FIG. 10 shows an example of the hardware configuration of the information processing apparatus 200. The hardware configuration of the information processing apparatus 200 is not limited to the above case. For example, the information processing apparatus 200 may be configured by part of the above configuration, such as excluding the drive device 206.

The selecting unit 221 abstracts a plurality of inputs based on the plurality of inputs. Moreover, the selecting unit 221 selects a common concept that is an abstract concept common to the plurality of inputs based on the result of the abstraction.

The generating unit 222 generates output data including the common concept based on the result of the selection by the selecting unit 221. For example, the generating unit 222 generates output data such as a sentence.

Thus, the information processing apparatus 200 has the selecting unit 221 and the generating unit 222. With such a configuration, the generating unit 222 can generate a new output using the result selected by the selecting unit 223. Consequently, output data corresponding to a plurality of inputs can be generated.

The information processing apparatus 200 described above can be implemented by installing a predetermined program in the information processing apparatus 200. Specifically, a program as another aspect of the present invention is a program for causing the information processing apparatus 200 to realize processes to abstract a plurality of inputs based on the plurality of inputs, select a common concept that is an abstract concept common to the plurality of inputs, and generate output data including the common concept based on the result of the selection.

Further, an information processing method realized by the information processing apparatus 200 described above is a method by the information processing apparatus 200 including abstracting a plurality of inputs based on the plurality of inputs, selecting a common concept that is an abstract concept common to the plurality of inputs, and generating output data including the common concept based on the result of the selection.

The invention of the program (or recording medium) or the information processing method having the above configuration also has the same actions and effects as the information processing apparatus 200 described above, and therefore, can achieve the abovementioned object of the present invention.

### <Supplementary Notes>

### (Supplementary Note 1)

An information processing apparatus comprising:

a selecting unit that abstracts a plurality of inputs based on the plurality of inputs and selects a common concept that is an abstract concept common to the plurality of inputs; and

a generating unit that generates output data including the common concept based on a result of the selection by the selecting unit.

### (Supplementary Note 2)

The information processing apparatus according to Supplementary Note 1, comprising:

a word acquiring unit that acquires a plurality of words based on the plurality of inputs; and

a word abstracting unit that performs abstraction processing to associate the word acquired by the word acquiring unit with an abstract concept that is a word with different abstraction level from the word, wherein:

the selecting unit selects a common concept common to the plurality of words based on a result of the processing by the word abstracting unit; and

the generating unit generates a sentence based on a result of the selection by the selecting unit.

### (Supplementary Note 3)

The information processing apparatus according to Supplementary Note 2, wherein

the generating unit generates a sentence based on a target of interest set in advance and the result of the selection by the selecting unit.

### (Supplementary Note 4)

The information processing apparatus according to Supplementary Note 3, wherein

the selecting unit selects a word or a group of words to be the target of interest and a common concept common to the other words.

### (Supplementary Note 5)

The information processing apparatus according to any one of Supplementary Notes 2 to 4, wherein

the word abstracting unit refers to concept information that is information showing a connection of words and groups of words and thereby performs the abstraction processing that is processing to generate a word cloud sentence in which the word is associated with the abstract concept that is the word with different abstraction level from the word.

### (Supplementary Note 6)

The information processing apparatus according to any one of Supplementary Notes 2 to 5, wherein

a value of the abstraction level increases as a number of connected words indicating a number of words and groups of words connected to a word and a group of words increases.

### (Supplementary Note 7)

The information processing apparatus according to any one of Supplementary Notes 2 to 6, comprising

an accepting unit that accepts input of a plurality of sentences as the plurality of inputs,

wherein the word acquiring unit acquires a word by performing natural language processing on the input sentences.

### (Supplementary Note 8)

The information processing apparatus according to any one of Supplementary Notes 1 to 7, wherein

the generating unit generates search information including the extracted abstract concept as output data,

the information processing apparatus comprising

a searching unit that searches the search information using the abstract concept acquired based on input information.

### (Supplementary Note 9)

An information processing method by an information processing apparatus, the method comprising:

abstracting a plurality of inputs based on the plurality of inputs and selecting a common concept that is an abstract concept common to the plurality of inputs; and

generating output data including the common concept based on a result of the selection.

### (Supplementary Note 10)

A computer program comprising instructions for causing an information processing apparatus to realize processes to:

abstract a plurality of inputs based on the plurality of inputs and select a common concept that is an abstract concept common to the plurality of inputs; and

generate output data including the common concept based on a result of the selection.

The programs described in the example embodiments and supplementary notes are stored in a storage device or recorded on a computer-readable recording medium. For example, the recording medium is a portable medium such as a flexible disk, an optical disk, a magneto-optical disk, and a semiconductor memory.

Although the present invention has been described above with reference to the example embodiments, the present invention is not limited to the example embodiments. The configurations and details of the present invention can be changed in various manners that can be understood by one skilled in the art within the scope of the present invention.

The present invention is based upon and claims the benefit of priority from Japanese patent application No. 2021-029501, filed on Feb. 26, 2021, the disclosure of which is incorporated herein in its entirety by reference.

### REFERENCE SIGNS LIST

100 sentence generation apparatus
110 operation input unit
120 screen display unit
130 communication FP unit
140 storing unit
141 concept information
142 sentence information
143 target-of-interest information
144 word cloud sentence information
145 generated sentence information
146 program
147 search information
150 operation processing unit
151 accepting unit
152 segmenting unit
153 word abstracting unit
154 common concept selecting unit
155 generating unit
156 output unit
157 searching unit
160 search apparatus
200 information processing apparatus
201 CPU
202 ROM
203 RAM
204 programs
205 storage device
206 drive device
207 communication interface
208 input/output interface
209 bus
210 recording medium
211 communication network
221 selecting unit
222 generating unit

What is claimed is:

1. An information processing apparatus comprising:
at least one memory configured to store instructions; and
at least one processor configured to execute the instructions to:
abstract a plurality of inputs based on the plurality of inputs and select a common concept that is an abstract concept common to the plurality of inputs; and
generate output data including the common concept based on a result of the selection.

2. The information processing apparatus according to claim 1, wherein the at least one processor is configured to execute the instructions to:
acquire a plurality of words based on the plurality of inputs;
perform abstraction processing to associate the acquired word with an abstract concept that is a word with different abstraction level from the word;
select a common concept common to the plurality of words based on a result of the processing; and
generate a sentence based on a result of the selection.

3. The information processing apparatus according to claim 2, wherein the at least one processor is configured to execute the instructions to
generate a sentence based on a target of interest set in advance and the result of the selection.

4. The information processing apparatus according to claim 3, wherein the at least one processor is configured to execute the instructions to
select a word or a group of words to be the target of interest and a common concept common to the other words.

5. The information processing apparatus according to claim 2, wherein the at least one processor is configured to execute the instructions to
refer to concept information that is information showing a connection of words and groups of words and thereby perform the abstraction processing that is processing to generate a word cloud sentence in which the word is associated with the abstract concept that is the word with different abstraction level from the word.

6. The information processing apparatus according to claim 2, wherein
a value of the abstraction level increases as a number of connected words indicating a number of words and groups of words connected to a word and a group of words increases.

7. The information processing apparatus according to claim 2, wherein the at least one processor is configured to execute the instructions to:
accept input of a plurality of sentences as the plurality of inputs, inputs; and
acquire a word by performing natural language processing on the input sentences.

8. The information processing apparatus according to claim 1, wherein the at least one processor is configured to execute the instructions to:
generate search information including the extracted abstract concept as output data, data; and
search the search information using the abstract concept acquired based on input information.

9. An information processing method by an information processing apparatus, the method comprising:
abstracting a plurality of inputs based on the plurality of inputs and selecting a common concept that is an abstract concept common to the plurality of inputs; and
generating output data including the common concept based on a result of the selection.

10. A non-transitory computer-readable recording medium on which a computer program is recorded, the computer program comprising instructions for causing an information processing apparatus to realize processes to:
abstract a plurality of inputs based on the plurality of inputs and select a common concept that is an abstract concept common to the plurality of inputs; and
generate output data including the common concept based on a result of the selection.
